(19) United States
(12) Patent Application Publication
(10) Pub. No.: US 2026/0361508 A1
(43) Pub. Date: Nov. 12, 2026

(54) IMPROVING USER PLANE FUNCTION PERFORMANCE IN A WIRELESS COMMUNICATION NETWORK

(71) Applicant: Lenovo (Singpore) Pte. Limited, Singapore (SG)

(72) Inventors: Andreas Kunz, Ladenburg (DE); Apostolis Salkintzis, Glika Nera (GR); Sheeba Backia Mary Baskaran, Friedrichsdorf (DE)

(73) Assignee: Lenovo (Singpore) Pte. Limited, Singapore (SG)

(21) Appl. No.: 19/125,862

(22) PCT Filed: Dec. 9, 2022
(86) PCT No.: PCT/EP2022/085159

§ 371 Date: Apr. 30, 2025

(30) Foreign Application Priority Data
Nov. 3, 2022 (GR) 20220100894

(51) Int. Cl. H04L 9/06; H04L 9/40; H04W 12/033; H04W 12/037

(52) U.S. Cl. CPC H04L 9/06; H04L 63/166; H04L 63/205; H04W 12/033; H04W 12/037

(57) ABSTRACT

There is provided an apparatus (408) comprising: a transceiver (325); and a processor (305) coupled to the transceiver (325), the processor (305) and the transceiver (325) configured to cause the apparatus (408) to: receive, from a network function (404) on another apparatus, a security policy for a Protocol Data Unit, PDU, session (412); receive, from a remote device (402), a first message (414), the first message indicating supported cipher suites including a NULL cipher suite, the NULL cipher suite defining that no encryption, or no integrity protection, or a combination thereof is to be applied; select the NULL cipher suite based on the received security policy; and send, to the remote device (402), a second message (418), the second message indicating the selected NULL cipher suite.

### FIELD

The subject matter disclosed herein relates generally to the field of improving user plane function performance in a wireless communication network. This document defines an apparatus, e.g. a user plane function, and a method.

### BACKGROUND

The QUIC protocol (more information regarding which may be found, for example, in IETF RFC 9000: “QUIC: A UDP-Based Multiplexed and Secure Transport”) may be used as a multipath protocol between a user equipment apparatus (UE) and a user plane function (UPF).

The QUIC protocol may be used, for example, in solution #2.2 in TR 23.700-53, “Study on access traffic steering, switching and splitting support in the 5G system architecture; Phase 3”, V1.1.0, October 2022.

According to IETF RFC 9001: “Using TLS to Secure QUIC”, QUIC may require the usage of Transport Layer Security (TLS) 1.3 with encryption according to IETF RFC 8446 “The Transport Layer Security (TLS) Protocol Version 1.3”.

### SUMMARY

The use of encryption according to RFC 8446 may be deemed reasonable for the intended use of QUIC in a normal client-application server environment in the Internet. However, the double encryption, i.e. encryption on both the QUIC layer and on the access layer, may be regarded as computational burden in the UPF. There is a desire to have an optional encryption on QUIC layer, for example in cases where access layer security is used.

One issue with the enabling of encryption for QUIC sessions on the application layer is that the performance in the UPF can decrease, for example by 3-4 times compared to a session without security. In other words, UPF performance can be severely impacted.

Current 5G security specifications of 3GPP TS 33.501: “Security architecture and procedures for 5G system” v17.7.0, September 2022, do not address this decrease in performance of the UPF.

Disclosed herein are procedures for improving UPF performance in a wireless communication network. Said procedures may be implemented by the UPF.

There is provided an apparatus comprising a transceiver and a processor coupled to the transceiver. The processor and the transceiver are configured to cause the apparatus to: receive, from a network function on another apparatus, a security policy for a Protocol Data Unit, PDU, session; receive, from a remote device, a first message, the first message indicating supported cipher suites including a NULL cipher suite, the NULL cipher suite defining that no encryption, or no integrity protection, or a combination thereof is to be applied; select the NULL cipher suite based on the received security policy; and send, to the remote device, a second message, the second message indicating the selected NULL cipher suite.

There is further provided a method for performance by an apparatus in a wireless communication network. The method comprises: receiving, by a transceiver, from a network function on another apparatus, a security policy for a Protocol Data Unit, PDU, session; receiving, by the transceiver, from a remote device, a first message, the first message indicating supported cipher suites including a NULL cipher suite, the NULL cipher suite defining that no encryption, or no integrity protection, or a combination thereof is to be applied; selecting, by a processor, the NULL cipher suite based on the received security policy; and sending, by the transceiver, to the remote device, a second message, the second message indicating the selected NULL cipher suite.

### BRIEF DESCRIPTION OF THE DRAWINGS

In order to describe the manner in which advantages and features of the disclosure can be obtained, a description of the disclosure is rendered by reference to certain apparatus and methods which are illustrated in the appended drawings. Each of these drawings depict only certain aspects of the disclosure and are not therefore to be considered to be limiting of its scope. The drawings may have been simplified for clarity and are not necessarily drawn to scale.

Methods and apparatus for improving UPF performance will now be described, by way of example only, with reference to the accompanying drawings, in which:

FIG. 1 illustrates a wireless communication system in which methods and apparatus for improving UPF performance may be implemented.

FIG. 2 depicts a user equipment apparatus that may be used for implementing the methods described herein.

FIG. 3 depicts further details of the network node that may be used for implementing the methods described herein.

FIG. 4 is a process flow chart showing a method for improving UPF performance in a wireless communication network.

FIG. 5 illustrates a process flow chart showing certain steps of the method for performance by an apparatus, such as a UPF, in a wireless communication network.

### DETAILED DESCRIPTION

As will be appreciated by one skilled in the art, aspects of this disclosure may be embodied as a system, apparatus, method, or program product. Accordingly, arrangements described herein may be implemented in an entirely hardware form, an entirely software form (including firmware, resident software, micro-code, etc.) or a form combining software and hardware aspects.

For example, the disclosed methods and apparatus may be implemented as a hardware circuit comprising custom very-large-scale integration (“VLSI”) circuits or gate arrays, off-the-shelf semiconductors such as logic chips, transistors, or other discrete components. The disclosed methods and apparatus may also be implemented in programmable hardware devices such as field programmable gate arrays, programmable array logic, programmable logic devices, or the like. As another example, the disclosed methods and apparatus may include one or more physical or logical blocks of executable code which may, for instance, be organized as an object, procedure, or function.

Furthermore, the methods and apparatus may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In certain arrangements, the storage devices only employ signals for accessing code.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random-access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain, or store, a program for use by or in connection with an instruction execution system, apparatus, or device.

Reference throughout this specification to an example of a particular method or apparatus, or similar language, means that a particular feature, structure, or characteristic described in connection with that example is included in at least one implementation of the method and apparatus described herein. Thus, reference to features of an example of a particular method or apparatus, or similar language, may, but do not necessarily, all refer to the same example, but mean “one or more but not all examples” unless expressly specified otherwise. The terms “including”, “comprising”, “having”, and variations thereof, mean “including but not limited to”, unless expressly specified otherwise. An enumerated listing of items does not imply that any or all of the items are mutually exclusive, unless expressly specified otherwise. The terms “a”, “an”, and “the” also refer to “one or more”, unless expressly specified otherwise.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one, and only one, of any single item in the list. For example, “one of A, B and C” includes only A, only B or only C and excludes combinations of A, B and C. As used herein, “a member selected from the group consisting of A, B, and C” includes one and only one of A, B, or C, and excludes combinations of A, B, and C.” As used herein, “a member selected from the group consisting of A, B, and C and combinations thereof” includes only A, only B, only C, a combination of A and B, a combination of B and C, a combination of A and C or a combination of A, B and C.

Furthermore, the described features, structures, or characteristics described herein may be combined in any suitable manner. In the following description, numerous specific details are provided, such as examples of programming, software modules, user selections, network transactions, database queries, database structures, hardware modules, hardware circuits, hardware chips, etc., to provide a thorough understanding of the disclosure. One skilled in the relevant art will recognize, however, that the disclosed methods and apparatus may be practiced without one or more of the specific details, or with other methods, components, materials, and so forth. In other instances, well-known structures, materials, or operations are not shown or described in detail to avoid obscuring aspects of the disclosure.

Aspects of the disclosed method and apparatus are described below with reference to schematic flowchart diagrams and/or schematic block diagrams of methods, apparatuses, systems, and program products. It will be understood that each block of the schematic flowchart diagrams and/or schematic block diagrams, and combinations of blocks in the schematic flowchart diagrams and/or schematic block diagrams, can be implemented by code. This code may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams.

The code may also be loaded onto a computer, other programmable data processing apparatus, or other devices to cause a series of operational steps to be performed on the computer, other programmable apparatus, or other devices to produce a computer implemented process such that the code which executes on the computer or other programmable apparatus provides processes for implementing the functions/acts specified in the schematic flowchart diagrams and/or schematic block diagram.

The schematic flowchart diagrams and/or schematic block diagrams in the Figures illustrate the architecture, functionality, and operation of possible implementations of apparatuses, systems, methods, and program products. In this regard, each block in the schematic flowchart diagrams and/or schematic block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

The description of elements in each figure may refer to elements of proceeding Figures. Like numbers refer to like elements in all Figures.

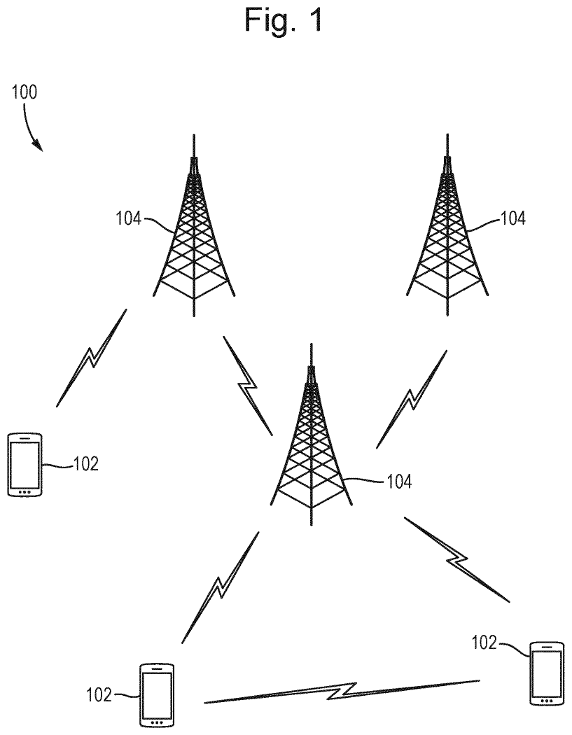

FIG. 1 depicts an embodiment of a wireless communication system in which methods and apparatus for improving UPF performance may be implemented. In one embodiment, the wireless communication system 100 includes remote units 102 and network units 104. Even though a specific number of remote units 102 and network units 104 are depicted in FIG. 1, one of skill in the art will recognize that any number of remote units 102 and network units 104 may be included in the wireless communication system 100.

In one embodiment, the remote units 102 may include computing devices, such as desktop computers, laptop computers, personal digital assistants (“PDAs”), tablet computers, smart phones, smart televisions (e.g., televisions connected to the Internet), set-top boxes, game consoles, security systems (including security cameras), vehicle on-board computers, network devices (e.g., routers, switches, modems), aerial vehicles, drones, or the like. In some embodiments, the remote units 102 include wearable devices, such as smart watches, fitness bands, optical head-mounted displays, or the like. Moreover, the remote units 102 may be referred to as subscriber units, mobiles, mobile stations, users, terminals, mobile terminals, fixed terminals, subscriber stations, UE, user terminals, a device, or by other terminology used in the art. The remote units 102 may communicate directly with one or more of the network units 104 via UL communication signals. In certain embodiments, the remote units 102 may communicate directly with other remote units 102 via sidelink communication.

The network units 104 may be distributed over a geographic region. In certain embodiments, a network unit 104 may also be referred to as an access point, an access terminal, a base, a base station, a Node-B, an eNB, a gNB, a Home Node-B, a relay node, a device, a core network, an aerial server, a radio access node, an AP, NR, a network entity, an Access and Mobility Management Function (“AMF”), a Unified Data Management Function (“UDM”), a Unified Data Repository (“UDR”), a UDM/UDR, a Policy Control Function (“PCF”), a Radio Access Network (“RAN”), an Network Slice Selection Function (“NSSF”), an operations, administration, and management (“OAM”), a session management function (“SMF”), a user plane function (“UPF”), an application function, an authentication server function (“AUSF”), security anchor functionality (“SEAF”), trusted non-3GPP gateway function (“TNGF”), an application function, a service enabler architecture layer (“SEAL”) function, a vertical application enabler server, an edge enabler server, an edge configuration server, a mobile edge computing platform function, a mobile edge computing application, an application data analytics enabler server, a SEAL data delivery server, a middleware entity, a network slice capability management server, or by any other terminology used in the art. The network units 104 are generally part of a radio access network that includes one or more controllers communicably coupled to one or more corresponding network units 104. The radio access network is generally communicably coupled to one or more core networks, which may be coupled to other networks, like the Internet and public switched telephone networks, among other networks. These and other elements of radio access and core networks are not illustrated but are well known generally by those having ordinary skill in the art.

In one implementation, the wireless communication system 100 is compliant with New Radio (NR) protocols standardized in 3GPP, wherein the network unit 104 transmits using an Orthogonal Frequency Division Multiplexing (“OFDM”) modulation scheme on the downlink (DL) and the remote units 102 transmit on the uplink (UL) using a Single Carrier Frequency Division Multiple Access (“SC-FDMA”) scheme or an OFDM scheme. More generally, however, the wireless communication system 100 may implement some other open or proprietary communication protocol, for example, WiMAX, IEEE 802.11 variants, GSM, GPRS, UMTS, LTE variants, CDMA2000, Bluetooth®, ZigBee, Sigfoxx, among other protocols. The present disclosure is not intended to be limited to the implementation of any particular wireless communication system architecture or protocol.

The network units 104 may serve a number of remote units 102 within a serving area, for example, a cell or a cell sector via a wireless communication link. The network units 104 transmit DL communication signals to serve the remote units 102 in the time, frequency, and/or spatial domain.

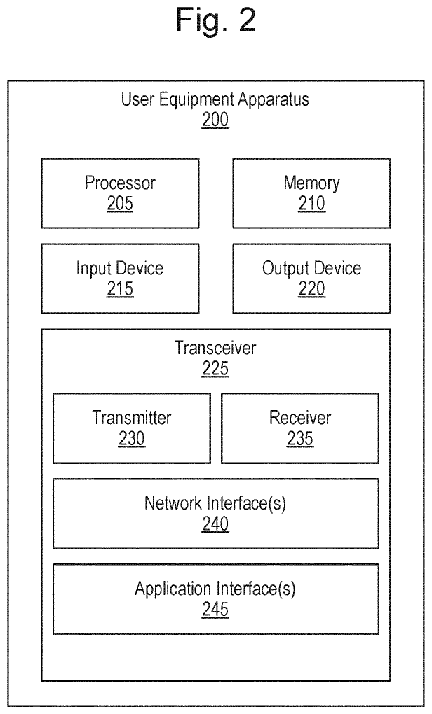

FIG. 2 depicts a user equipment apparatus 200 that may be used for implementing the methods described herein. The user equipment apparatus 200 is used to implement one or more of the solutions described herein. The user equipment apparatus 200 is in accordance with one or more of the user equipment apparatuses described in embodiments herein. In particular, the user equipment apparatus 200 may be in accordance with the remote units 102 of FIG. 1. The user equipment apparatus 200 includes a processor 205, a memory 210, an input device 215, an output device 220, and a transceiver 225.

The input device 215 and the output device 220 may be combined into a single device, such as a touchscreen. In some implementations, the user equipment apparatus 200 does not include any input device 215 and/or output device 220. The user equipment apparatus 200 may include one or more of: the processor 205, the memory 210, and the transceiver 225, and may not include the input device 215 and/or the output device 220.

As depicted, the transceiver 225 includes at least one transmitter 230 and at least one receiver 235. The transceiver 225 may communicate with one or more cells (or wireless coverage areas) supported by one or more base units. The transceiver 225 may be operable on unlicensed spectrum. Moreover, the transceiver 225 may include multiple UE panels supporting one or more beams. Additionally, the transceiver 225 may support at least one network interface 240 and/or application interface 245. The application interface(s) 245 may support one or more APIs. The network interface(s) 240 may support 3GPP reference points, such as Uu, N1, PC5, etc. Other network interfaces 240 may be supported, as understood by one of ordinary skill in the art.

The processor 205 may include any known controller capable of executing computer-readable instructions and/or capable of performing logical operations. For example, the processor 205 may be a microcontroller, a microprocessor, a central processing unit (“CPU”), a graphics processing unit (“GPU”), an auxiliary processing unit, a field programmable gate array (“FPGA”), or similar programmable controller. The processor 205 may execute instructions stored in the memory 210 to perform the methods and routines described herein. The processor 205 is communicatively coupled to the memory 210, the input device 215, the output device 220, and the transceiver 225.

The processor 205 may control the user equipment apparatus 200 to implement the user equipment apparatus behaviors described herein. The processor 205 may include an application processor (also known as “main processor”) which manages application-domain and operating system (“OS”) functions and a baseband processor (also known as “baseband radio processor”) which manages radio functions.

The memory 210 may be a computer readable storage medium. The memory 210 may include volatile computer storage media. For example, the memory 210 may include a RAM, including dynamic RAM (“DRAM”), synchronous dynamic RAM (“SDRAM”), and/or static RAM (“SRAM”). The memory 210 may include non-volatile computer storage media. For example, the memory 210 may include a hard disk drive, a flash memory, or any other suitable non-volatile computer storage device. The memory 210 may include both volatile and non-volatile computer storage media.

The memory 210 may store data related to implement a traffic category field as described herein. The memory 210 may also store program code and related data, such as an operating system or other controller algorithms operating on the apparatus 200.

The input device 215 may include any known computer input device including a touch panel, a button, a keyboard, a stylus, a microphone, or the like. The input device 215 may be integrated with the output device 220, for example, as a touchscreen or similar touch-sensitive display. The input device 215 may include a touchscreen such that text may be input using a virtual keyboard displayed on the touchscreen and/or by handwriting on the touchscreen. The input device 215 may include two or more different devices, such as a keyboard and a touch panel.

The output device 220 may be designed to output visual, audible, and/or haptic signals. The output device 220 may include an electronically controllable display or display device capable of outputting visual data to a user. For example, the output device 220 may include, but is not limited to, a Liquid Crystal Display (“LCD”), a Light-Emitting Diode (“LED”) display, an Organic LED (“OLED”) display, a projector, or similar display device capable of outputting images, text, or the like to a user. As another, non-limiting, example, the output device 220 may include a wearable display separate from, but communicatively coupled to, the rest of the user equipment apparatus 200, such as a smart watch, smart glasses, a heads-up display, or the like. Further, the output device 220 may be a component of a smart phone, a personal digital assistant, a television, a table computer, a notebook (laptop) computer, a personal computer, a vehicle dashboard, or the like.

The output device 220 may include one or more speakers for producing sound. For example, the output device 220 may produce an audible alert or notification (e.g., a beep or chime). The output device 220 may include one or more haptic devices for producing vibrations, motion, or other haptic feedback. All, or portions, of the output device 220 may be integrated with the input device 215. For example, the input device 215 and output device 220 may form a touchscreen or similar touch-sensitive display. The output device 220 may be located near the input device 215.

The transceiver 225 communicates with one or more network functions of a mobile communication network via one or more access networks. The transceiver 225 operates under the control of the processor 205 to transmit messages, data, and other signals and also to receive messages, data, and other signals. For example, the processor 205 may selectively activate the transceiver 225 (or portions thereof) at particular times in order to send and receive messages.

The transceiver 225 includes at least one transmitter 230 and at least one receiver 235. The one or more transmitters 230 may be used to provide uplink communication signals to a base unit of a wireless communication network. Similarly, the one or more receivers 235 may be used to receive downlink communication signals from the base unit. Although only one transmitter 230 and one receiver 235 are illustrated, the user equipment apparatus 200 may have any suitable number of transmitters 230 and receivers 235. Further, the transmitter(s) 230 and the receiver(s) 235 may be any suitable type of transmitters and receivers. The transceiver 225 may include a first transmitter/receiver pair used to communicate with a mobile communication network over licensed radio spectrum and a second transmitter/receiver pair used to communicate with a mobile communication network over unlicensed radio spectrum.

The first transmitter/receiver pair may be used to communicate with a mobile communication network over licensed radio spectrum and the second transmitter/receiver pair used to communicate with a mobile communication network over unlicensed radio spectrum may be combined into a single transceiver unit, for example a single chip performing functions for use with both licensed and unlicensed radio spectrum. The first transmitter/receiver pair and the second transmitter/receiver pair may share one or more hardware components. For example, certain transceivers 225, transmitters 230, and receivers 235 may be implemented as physically separate components that access a shared hardware resource and/or software resource, such as for example, the network interface 240.

One or more transmitters 230 and/or one or more receivers 235 may be implemented and/or integrated into a single hardware component, such as a multi-transceiver chip, a system-on-a-chip, an Application-Specific Integrated Circuit (“ASIC”), or other type of hardware component. One or more transmitters 230 and/or one or more receivers 235 may be implemented and/or integrated into a multi-chip module. Other components such as the network interface 240 or other hardware components/circuits may be integrated with any number of transmitters 230 and/or receivers 235 into a single chip. The transmitters 230 and receivers 235 may be logically configured as a transceiver 225 that uses one more common control signals or as modular transmitters 230 and receivers 235 implemented in the same hardware chip or in a multi-chip module.

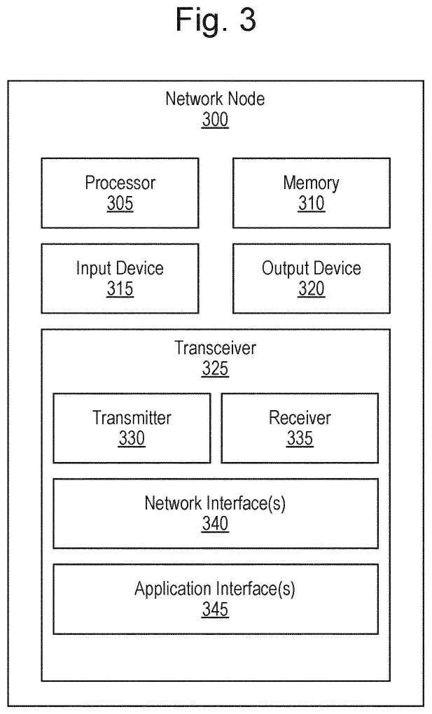

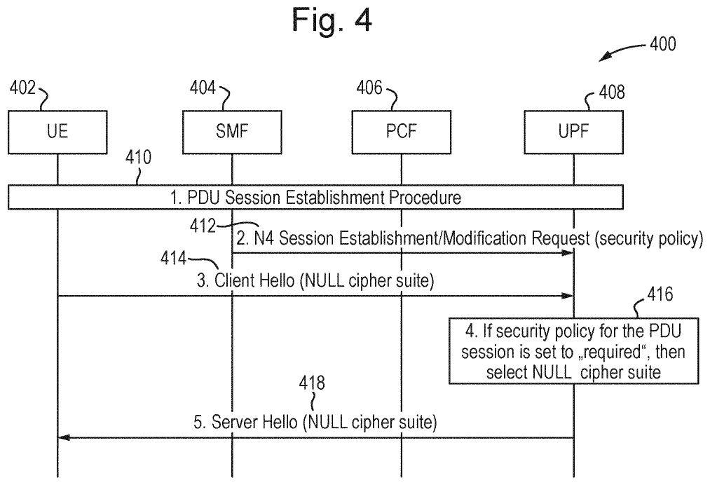

FIG. 3 depicts further details of the network node 300 that may be used for implementing the methods described herein. The network node 300 may be one implementation of an entity in the wireless communication network, e.g. in one or more of the wireless communication networks described herein. The network node 300 may be, for example, the UE 200 described above, or a Network Function (NF) or Application Function (AF), or another entity, of one or more of the wireless communications networks of embodiments described herein, e.g. the UPF 408 of FIG. 4. The network node 300 includes a processor 305, a memory 310, an input device 315, an output device 320, and a transceiver 325.

The input device 315 and the output device 320 may be combined into a single device, such as a touchscreen. In some implementations, the network node 300 does not include any input device 315 and/or output device 320. The network node 300 may include one or more of: the processor 305, the memory 310, and the transceiver 325, and may not include the input device 315 and/or the output device 320.

As depicted, the transceiver 325 includes at least one transmitter 330 and at least one receiver 335. Here, the transceiver 325 communicates with one or more remote units 200. Additionally, the transceiver 325 may support at least one network interface 340 and/or application interface 345. The application interface(s) 345 may support one or more APIs. The network interface(s) 340 may support 3GPP reference points, such as Uu, N1, N2 and N3. Other network interfaces 340 may be supported, as understood by one of ordinary skill in the art.

The processor 305 may include any known controller capable of executing computer-readable instructions and/or capable of performing logical operations. For example, the processor 305 may be a microcontroller, a microprocessor, a CPU, a GPU, an auxiliary processing unit, a FPGA, or similar programmable controller. The processor 305 may execute instructions stored in the memory 310 to perform the methods and routines described herein. The processor 305 is communicatively coupled to the memory 310, the input device 315, the output device 320, and the transceiver 325.

The memory 310 may be a computer readable storage medium. The memory 310 may include volatile computer storage media. For example, the memory 310 may include a RAM, including dynamic RAM (“DRAM”), synchronous dynamic RAM (“SDRAM”), and/or static RAM (“SRAM”). The memory 310 may include non-volatile computer storage media. For example, the memory 310 may include a hard disk drive, a flash memory, or any other suitable non-volatile computer storage device. The memory 310 may include both volatile and non-volatile computer storage media.

The memory 310 may store data related to establishing a multipath unicast link and/or mobile operation. For example, the memory 310 may store parameters, configurations, resource assignments, policies, and the like, as described herein. The memory 310 may also store program code and related data, such as an operating system or other controller algorithms operating on the network node 300.

The input device 315 may include any known computer input device including a touch panel, a button, a keyboard, a stylus, a microphone, or the like. The input device 315 may be integrated with the output device 320, for example, as a touchscreen or similar touch-sensitive display. The input device 315 may include a touchscreen such that text may be input using a virtual keyboard displayed on the touchscreen and/or by handwriting on the touchscreen. The input device 315 may include two or more different devices, such as a keyboard and a touch panel.

The output device 320 may be designed to output visual, audible, and/or haptic signals. The output device 320 may include an electronically controllable display or display device capable of outputting visual data to a user. For example, the output device 320 may include, but is not limited to, an LCD display, an LED display, an OLED display, a projector, or similar display device capable of outputting images, text, or the like to a user. As another, non-limiting, example, the output device 320 may include a wearable display separate from, but communicatively coupled to, the rest of the network node 300, such as a smart watch, smart glasses, a heads-up display, or the like. Further, the output device 320 may be a component of a smart phone, a personal digital assistant, a television, a table computer, a notebook (laptop) computer, a personal computer, a vehicle dashboard, or the like.

The output device 320 may include one or more speakers for producing sound. For example, the output device 320 may produce an audible alert or notification (e.g., a beep or chime). The output device 320 may include one or more haptic devices for producing vibrations, motion, or other haptic feedback. All, or portions, of the output device 320 may be integrated with the input device 315. For example, the input device 315 and output device 320 may form a touchscreen or similar touch-sensitive display. The output device 320 may be located near the input device 315.

The transceiver 325 includes at least one transmitter 330 and at least one receiver 335. The one or more transmitters 330 may be used to communicate with the UE, as described herein. Similarly, the one or more receivers 335 may be used to communicate with network functions in the PLMN and/or RAN, as described herein. Although only one transmitter 330 and one receiver 335 are illustrated, the network node 300 may have any suitable number of transmitters 330 and receivers 335. Further, the transmitter(s) 330 and the receiver(s) 335 may be any suitable type of transmitters and receivers.

As discussed above, one issue with the enabling of encryption for QUIC sessions on the application layer is that the performance in the UPF can decrease. To improve UPF performance, the present disclosure introduces a NULL cipher suite, e.g. for use in TLS 1.3. Also, the UE may indicate this capability to the UPF, e.g. in a TLS exchange when setting up the QUIC session. The UPF can decide whether to use encryption or not for this session, under consideration of the security policy for the AS layer (UE-gNB), i.e. UP protection (integrity and/or confidentiality).

According to TS 33.501, clause 6.6.1, “The SMF shall provide UP security policy for a PDU session to the ng-eNB/gNB during the PDU session establishment procedure as specified in TS 23.502. The UP security policy shall indicate whether UP confidentiality and/or UP integrity protection shall be activated or not for all Data Radio Bearers (DRB) belonging to that PDU session. The UP security policy shall be used to activate UP confidentiality and/or UP integrity for all DRBs belonging to the PDU session.”

In embodiments described herein, the security policy is known by the UPF, so that the UPF can make a decision on whether to select NULL cipher suite for use, when the UE includes a NULL cipher suite in the TLS message for the QUIC session.

Further, in embodiments described herein, the TLS 1.3 protocol is profiled with the NULL cipher suite option for the ciphering and integrity protection algorithms.

In embodiments described herein, the support cipher suites in clause B.4 of RFC 8446 may be enhanced, or an integrity protection only algorithm of IETF RFC 9150 may be used, or IETF RFC 9150 may be enhanced to support a NULL cipher suite option.

A (symmetric) cipher suite typically defines the pair of the Authenticated Encryption with Associated Data (AEAD) algorithm and hash algorithm to be used with Hash-based Message Authentication Code (HMAC)-based Extract-and-Expand Key Derivation Function (HKDF).

Cipher suite names typically follow the following naming convention:

This disclosure defines the following cipher suites for use with TLS 1.3.

In other words, the TLS 1.3 cipher suites are enhanced or expanded to include a NULL cipher suite, in particular the cipher suite TLS_NULL_NULL in this embodiment.

When using the cipher suite TLS_NULL_NULL, the data is not encrypted, and the message authentication code (MAC) size is zero, implying that no MAC is used. This may be similar to TLS 1.2 (see, for example, IETF RFC 5346 “The Transport Layer Security (TLS) Protocol Version 1.2”).

In some embodiments, instead of or in addition to including the cipher suite TLS_NULL_NULL, a cipher suite such as that defined in IETF RFC 9150 “TLS 1.3 Authentication and Integrity-Only Cipher Suites”, in clause 4 “Cryptographic Negotiation Using Integrity-Only Cipher Suites”, can be used. That is to say, a cipher suite that provides for no encryption, but does provide integrity protection, may be implemented as the NULL cipher suite.

The UE may include the NULL cipher suite in the Client Hello message to the UPF, for example as follows:

```
uint16 ProtocolVersion;
  opaque Random[32];
  uint8 CipherSuite[2]; /* Cryptographic suite selector */
  struct {
    ProtocolVersion legacy_version = 0x0303; /* TLS v1.2 */
    Random random;
    opaque legacy_session_id<0..32>;
    CipherSuite cipher_suites<2..2\hat{ }16−2>;
    opaque legacy_compression_methods<1..2\hat{ }8−1>;
    Extension extensions<8..2\hat{ }16−1>;
  } ClientHello;
```

The cipher_suite parameter indicates the single cipher suite selected by the UPF from the list in ClientHello.cipher_suites. The UPF decides, based on the security policy of this PDU session, whether to select the NULL cipher suite or a different cipher suite (e.g. that provides encryption and integrity protection).

FIG. 4 is a process flow chart showing an embodiment of a method 400 for improving UPF performance in a wireless communication network. The method 400 illustrates the overall changes implemented to enable the NULL cipher suite for a QUIC session.

The method 400 may involve a UE 402, an SMF 404, a PCF 406, and a UPF 408.

The UE 402, SMF 404, the PCF 406, and/or the UPF 408 may be the same as or in accordance with any of the UEs described herein. For example, the UE 402 may be the same as the UE 200 shown in FIG. 2 and described in more detail earlier above.

The SMF 404, the PCF 406, and/or the UPF 408 may be the same as or in accordance with any network entity, function, or node described herein. For example, the SMF 404, the PCF 406, and/or the UPF 408 may be the same as the network node 300 shown in FIG. 3 and described in more detail earlier above.

At step 410, the UE 402 establishes a PDU session. This PDU session may be established in any appropriate way, such as in accordance with the procedure presented in TS 23.502, clause 4.3.2.2.1.

At step 412, the SMF 404 provides a security policy for the PDU Session to the UPF 408.

At step 414, the UE 402 establishes a QUIC session. This QUIC session may be established in any appropriate way, such as in accordance with the solution #2.2 in TR 23.700-53.

The UE 402 includes the NULL cipher suite (e.g. TLS_NULL_NULL) in the CipherSuite list of the Client Hello message.

Alternatively or additionally, a cipher suite such as that defined in IETF RFC 9150 “TLS 1.3 Authentication and Integrity-Only Cipher Suites”, in clause 4 “Cryptographic Negotiation Using Integrity-Only Cipher Suites” can be included in the CipherSuite list of the Client Hello message. Such cipher suites may provide for no encryption, but may provide for integrity protection.

Thus, at step 414, the UE 402 sends a Client Hello message including the NULL cipher suite in the CipherSuite list to the UPF 408.

At step 416, the UPF 408 checks whether the security policy of the PDU session (received at step 412) is set to a first value (which, in this embodiment, is the value “required”, or an equivalent).

If the security policy is set to the first value (i.e. “required”), the UPF 408 selects the NULL cipher suite from the CipherSuite list.

In this embodiment, the security policy is related to the encryption and/or integrity on the radio layer. The security policy being set to the first value (i.e. “required”) indicates that security (e.g. encryption and/or integrity protection) over the radio is provided. Thus, the UPF 408 may determine or infer that security is not needed on the application layer, since the communication is 3GPP internal between UE and UPF, and accordingly may select the NULL cipher suite.

Alternatively, if the security policy is set to a second value (which, in this embodiment, is the value “preferred” or an equivalent, or “optional” or an equivalent), the UPF 408 may select the NULL cipher suite from the CipherSuite list. The security policy being set to the second value (i.e. “preferred”) may indicate that security on the application layer is optional, and accordingly the UPF 408 may optionally select the NULL cipher suite from the CipherSuite list, or alternatively may selected a different cipher suite with encryption and integrity protection.

Alternatively, if the security policy is set to a third value (which, in this embodiment, is the value “not needed” or an equivalent, or “not provided” or an equivalent), the UPF 408 selects, from the CipherSuite list, a cipher suite with encryption and integrity protection other than the NULL cipher suite. The security policy being set to the third value (i.e. “not needed”) may indicate that security on the radio layer is not provided. Thus, the UPF 408 may determine or infer that security on the application layer should be provided, and accordingly the UPF 408 selects a cipher suite that provides encryption and integrity protection.

At step 418, the UPF 408 sends a Server Hello message with the selected cipher suite. If the UPF 408 selected the NULL cipher suite, then this may be included in the Server Hello message. The Server Hello message may be sent from the UPF 408 to the UE 402.

After step 418, the UE 402 and the UPF 408 can exchange messages. If the NULL cipher suite was selected, these exchanged messages may be unencrypted messages and/or may include no integrity protection. Additional TLS messages may be exchanged between the UE 402 and the UPF 408.

Thus, an embodiment of a method 400 for improving UPF performance in a wireless communication network is provided.

In an aspect, there is provided an apparatus (e.g. the UPF) comprising a transceiver, and a processor coupled to the transceiver. The processor and the transceiver are configured to cause the apparatus to: receive, from a network function on another apparatus (e.g. the SMF), a security policy for a PDU session; receive, from a remote device (e.g. a UE), a first message (e.g. the Client Hello message), the first message indicating, comprising, specifying, or defining supported cipher suites including a NULL cipher suite, the NULL cipher suite defining that no encryption, or no integrity protection, or a combination thereof is to be applied (e.g. to messages in the application layer between the apparatus and the remote device); select the NULL cipher suite based on the received security policy; and send, to the remote device, a second message (e.g. the Server Hello response message), the second message indicating, comprising, specifying, or defining the selected NULL cipher suite.

The processor and the transceiver may be further configured to cause the apparatus to, via the PDU session, send to and/or receive from the remote device one or more messages protected (e.g., encrypted and/or integrity protected) using the NULL cipher suite, for example in the application layer.

The first message may be a Client Hello message such as defined in TLS 1.3.

The second message may be a Server Hello response message, such as defined in TLS 1.3.

The first message and the second message may be sent between the apparatus and the remote device as part of a TLS handshake process, such as that defined by TLS 1.3.

The first message and the second message may be sent between the apparatus and the remote device as part of setting up a QUIC session between the apparatus and the remote device.

The NULL cipher suite may provide that no key exchange between the apparatus and the remote device is performed (e.g. in the application layer), i.e. it may define NULL key exchange. The NULL cipher suite may provide that no authentication between the apparatus and the remote device is performed (e.g. in the application layer), i.e. it may define NULL authentication. The NULL cipher suite may provide that no encryption of messages between the apparatus and the remote device is performed (e.g. in the application layer), i.e. it may define NULL encryption.

The processor and the transceiver may be further configured to cause the apparatus to select the NULL cipher suite in response to the received security policy specifying a first value. The first value may indicate that security (e.g. protection, which may include encryption and/or integrity protection) on a radio layer is required or mandatory. The first value may be the value “required”. By determining that security on the radio layer is required or mandatory (i.e. will be provided), the apparatus may determine or infer that protection, e.g. encryption and/or integrity protection, on the application layer is not needed, since the communication is 3GPP internal between the UE and the UPF, and accordingly may select the NULL cipher suite.

The apparatus may be a User Plane Function, UPF, such as the UPF 408 described in more detail earlier above with reference to FIG. 4. The network function may be a Session Management Function, SMF, such as the SMF 404 described in more detail earlier above with reference to FIG. 4. The remote device may be a user equipment, UE, apparatus, such as the UE 402 described in more detail earlier above with reference to FIG. 4, or the UE 200 described in more detail earlier above with reference to FIG. 2.

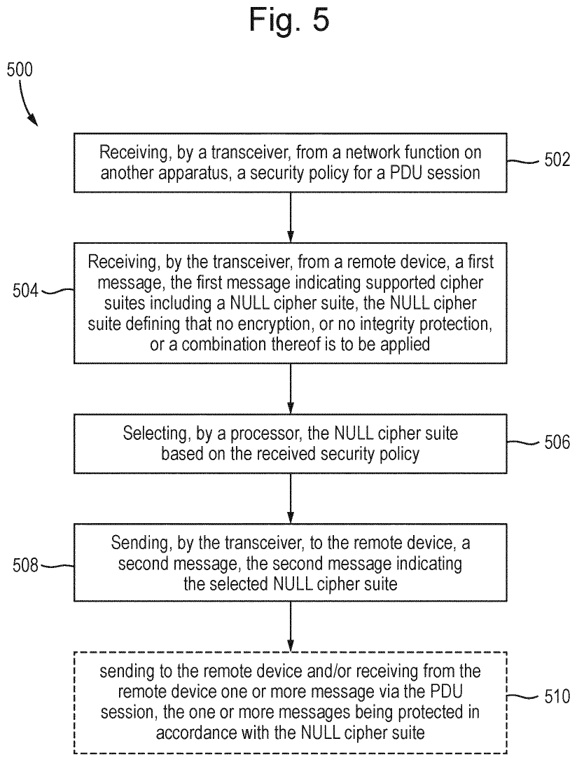

In a further aspect, there is provided a method for performance by an apparatus in a wireless communication network. FIG. 5 illustrates a process flow chart showing certain steps of the method 500 for performance by an apparatus in a wireless communication network. The method 500 may be performed by a User Plane Function, UPF, such as the UPF 408 described in more detail earlier above with reference to FIG. 4. In certain embodiments, the method 500 may be performed by a processor executing program code, for example, a microcontroller, a microprocessor, a CPU, a GPU, an auxiliary processing unit, a FPGA, or the like.

The method 500 comprises: receiving 502, by a transceiver, from a network function on another apparatus (e.g. the SMF), a security policy for a PDU session; receiving 504, by the transceiver, from a remote device (e.g. the UE), a first message (e.g. the Client Hello message), the first message indicating, comprising, specifying, or defining supported cipher suites including a NULL cipher suite, the NULL cipher suite defining that no encryption, or no integrity protection, or a combination thereof is to be applied (e.g. to messages in the application layer between the apparatus and the remote device); selecting 506, by a processor, the NULL cipher suite based on the received security policy; and sending 508, by the transceiver, to the remote device, a second message (e.g. the Server Hello response message), the second message indicating, comprising, specifying, or defining the selected NULL cipher suite.

The method may further comprise sending to the remote device and/or receiving from 510 the remote device one or more message via the PDU session, the one or more messages being protected using the NULL cipher suite.

Conventionally, if security protection is activated on the AS and the QUIC layer, then the performance of the UPF may be 3-4 times less compared to if there was no security activation on the QUIC layer.

Advantageously, use of the NULL cipher suite tends to allow for the disabling of the encryption and/or integrity protection e.g. for TLS 1.3 and/or for QUIC. In operation, the UPF is provisioned with the security policy of the PDU session and can decide, based on the security policy, whether to use NULL cipher suite to disable certain protections, or not.

Embodiments described herein introduce a NULL cipher suite, e.g. for TLS 1.3. The UE may indicate this capability in the TLS exchange when setting up the QUIC session. The UPF can decide whether to use encryption or not for the session, under consideration of the security policy for the AS layer (UE-gNB), i.e. UP protection (integrity and/or confidentiality).

It should be noted that the above-mentioned methods and apparatus illustrate rather than limit the invention, and that those skilled in the art will be able to design many alternative arrangements without departing from the scope of the appended claims. The word “comprising” does not exclude the presence of elements or steps other than those listed in a claim, “a” or “an” does not exclude a plurality, and a single processor or other unit may fulfil the functions of several units recited in the claims. Any reference signs in the claims shall not be construed so as to limit their scope.

Further, while examples have been given in the context of particular communication standards, these examples are not intended to be the limit of the communication standards to which the disclosed method and apparatus may be applied. For example, while specific examples have been given in the context of 3GPP, the principles disclosed herein can also be applied to another wireless communication system, and indeed any communication system which uses routing rules.

The method may also be embodied in a set of instructions, stored on a computer readable medium, which when loaded into a computer processor, Digital Signal Processor (DSP) or similar, causes the processor to carry out the hereinbefore described methods.

The described methods and apparatus may be practiced in other specific forms. The described methods and apparatus are to be considered in all respects only as illustrative and not restrictive. The scope of the invention is, therefore, indicated by the appended claims rather than by the foregoing description. All changes which come within the meaning and range of equivalency of the claims are to be embraced within their scope.

The following abbreviations are relevant in the field addressed by this document.

| | |
|---|---|
| 5GC | 5G Core Network |
| 5GS | 5G System |
| AEAD | Authenticated Encryption with Associated Data |
| AMF | Access and Mobility Management Function |
| AS | Access Stratum |
| AUSF | Authentication Server Function |
| EAP | Extensible Authentication Protocol |
| eNB | Evolved Node-B |
| EPC/EPS | Evolved packet core / Evolved packet system |
| HKDF | HMAC-based Extract-and-Expand Key Derivation Function |
| HMAC | Hash-based Message Authentication Code |
| ID | Identity |
| IE | Information Element |
| IKEv2 | Internet Key Exchange Protocol Version 2 |
| MM | Mobility Management |
| MPQUIC | Multipath QUIC |
| NAI | Network Access Identifier |
| NAS | Non Access Stratum |
| NEF | Network Exposure Function |
| NF | Network Function |
| NR | New Radio |
| PCF | Policy Control Function |
| PDCP | Packet Data Convergence Protocol |
| PDU | Protocol Data Unit |
| PLMN | Public Land Mobile Network |
| RAN | Radio Access Network |
| RAT | Radio Access Technology/Type |
| SA | IKE Security Association |
| SEAF | Security Anchor Functionality |
| SM | Session Management |
| SMC | Security Mode Command |
| SMF | Session Management Function |
| SUCI | Subscription Concealed Identifier |
| SUPI | Subscription Permanent Identifier |
| TLS | Transport Layer Security |
| UDM | Unified Data Management |
| UDR | Unified Data Repository |
| UE | User Equipment |

1. An apparatus for wireless communication, comprising:
at least one memory; and
at least one processor coupled with the at least one memory and configured to cause the apparatus to:
receive a security policy for a protocol data unit (PDU) session;
receive a first message that indicates supported cipher suites including a NULL cipher suite, wherein the NULL cipher suite defines that at least one of no encryption or no integrity protection is to be applied;
select the NULL cipher suite based at least in part on the received security policy; and
send a second message that indicates the selected NULL cipher suite.

2. The apparatus of claim 1, wherein the at least one processor is further configured to cause the apparatus to, via the PDU session, at least one of send or receive one or more messages protected using the NULL cipher suite.

3. The apparatus of claim 1, wherein:
the first message is a Client Hello message; and
the second message is a Server Hello response message.

4. The apparatus of claim 1, wherein the at least one processor is further configured to cause the apparatus to receive the first message and send the second message as part of a transport layer security (TLS) handshake.

5. The apparatus of claim 1, wherein the at least one processor is further configured to cause the apparatus to receive the first message and send the second message as part of setting up a QUIC session.

6. The apparatus of claim 1, wherein the NULL cipher suite provides that no encryption of messages between the apparatus and a remote device is performed.

7. The apparatus of claim 1, wherein the NULL cipher suite provides that no key exchange between the apparatus and a remote device is performed.

8. The apparatus of claim 1, wherein the NULL cipher suite provides that no authentication between the apparatus and a remote device is performed.

9. The apparatus of claim 1, wherein the at least one processor is further configured to cause the apparatus to select the NULL cipher suite in response to the received security policy specifying a first value, wherein the first value indicates that security on a radio layer is required.

10. The apparatus of claim 9, wherein the first value is “required”.

11. The apparatus of claim 1, wherein the apparatus implements a user lane function (UPF).

12. The apparatus of claim 1, wherein to receive the security policy, the at least one processor is further configured to cause the apparatus to receive the security policy from a session management function (SMF).

13. The apparatus of claim 1, wherein to receive the first message, the at least one processor is further configured to cause the apparatus to receive the first message from a user equipment (UE).

14. A method performed by an apparatus, the method comprising:
receiving a security policy for a protocol data unit (PDU) session;
receiving a first message that indicates supported cipher suites including a NULL cipher suite, wherein the NULL cipher suite defines that at least one of no encryption or no integrity protection is to be applied;
selecting, by a processor, the NULL cipher suite based at least in part on the received security policy; and
sending a second message that indicates the selected NULL cipher suite.

15. The method of claim 14, further comprising at least one of sending or receiving one or more messages via the PDU session, wherein the one or more messages are protected using the NULL cipher suite.

16. A user equipment (UE) for wireless communication, comprising:
at least one memory; and
at least one processor coupled with the at least one memory and configured to cause the UE to:
transmit a security policy for a protocol data unit (PDU) session;
transmit a first message that indicates supported cipher suites including a NULL cipher suite, wherein the NULL cipher suite defines that at least one of no encryption or no integrity protection is to be applied; and
receive a second message that indicates a selected NULL cipher suite.

17. The UE of claim 16, wherein the at least one processor is further configured to cause the UE to, via the PDU session, at least one of send or receive one or more messages protected using the NULL cipher suite.

18. The UE of claim 16, wherein:
the first message is a Client Hello message; and
the second message is a Server Hello response message.

19. The UE of claim 16, wherein the at least one processor is further configured to cause the UE to transmit the first message and receive the second message as part of a transport layer security (TLS) handshake.

20. A method performed by a user equipment (UE), the method comprising:
transmitting a security policy for a protocol data unit (PDU) session;
transmitting a first message that indicates supported cipher suites including a NULL cipher suite, wherein the NULL cipher suite defines that at least one of no encryption or no integrity protection is to be applied; and
receiving a second message that indicates a selected NULL cipher suite.
